(19) United States
(12) Patent Application Publication
(10) Pub. No.: US 2018/0154293 A1
(43) Pub. Date: Jun. 7, 2018

(54) FILTER MOUNTS FOR A PORTABLE FAN AND METHODS FOR MOUNTING A FILTER TO A PORTABLE FAN

(71) Applicant: Zipwall, LLC, Arlington, MA (US)

(72) Inventor: Jeffrey P. Whittemore, Arlington, MA (US)

(21) Appl. No.: 15/822,423

(22) Filed: Nov. 27, 2017

Related U.S. Application Data
(60) Provisional application No. 62/428,689, filed on Dec. 1, 2016.

(51) Int. Cl. B01D 46/00; F04D 29/70

(52) U.S. Cl. CPC B01D 46/001; B01D 2279/40; B01D 46/0043; F04D 29/703

(57) ABSTRACT

A filter mount removably attaches a filter to a box fan. The filter mount includes an elastic band, a fan coupler at a first end of the elastic band and a filter coupler at a second end of the elastic band. The fan coupler removably attaches to a grate of a grill of a fan. The filter coupler removably attaches to a filter.

### RELATED APPLICATIONS

This application claims the benefit of U.S. Provisional Patent Application Ser. No. 62/428,689, filed Dec. 1, 2016, the content of which is incorporated herein by reference in its entirety.

### BACKGROUND OF THE INVENTION

Portable fans, such as box fans, are popular as a cost-efficient means for cooling or ventilating interior areas of commercial and residential buildings. Box fans are inexpensive, light, and portable, and can be easily repositioned to provide a desired interior air flow.

Filters have been applied to box fans as a means for removing air-borne contaminants from the air flow. A number of mounting configurations have been devised that secure a filter to a box fan. These mounting configurations require specialized attachment hardware which is semi-permanent or permanent, can disfigure the fan body, and cannot be re-used on another fan. U.S. Pat. No. 7,670,401, the content of which is incorporated herein by reference, discloses a filter mount. The filter mount includes a filter frame into which a fan filter can be inserted. The filter mount is is removably attachable to a box fan.

### SUMMARY

Embodiments of the present inventive concepts are directed to a filter mount for a box fan. The filter mount is removably mountable between a portable fan and a standard air filter, such as the type of filter commonly used in residential heating systems, and does not cause any permanent disfigurement to the box fan body. The filter mount is preferably sized such that a substantial amount of air flow passes through the filter.

In one embodiment, the filter mount is in the form of a plurality of straps. The straps are provided to secure the filter to the fan body, such that the filter is readily removable from the fan body. In some embodiments, the straps comprise elastic bands. Tension in the elastic bands, when mounted, secures the filter to a grill of a fan. One end of the strap includes a fan coupler for coupling the elastic band to the grill of the fan and an opposite end of the strap includes a filter coupler for coupling the elastic band directly to the filter. The fan coupler includes features that attach to the grill of a fan, for example, features that mate with one or more grill apertures. The filter coupler includes features that attach to the filter, for example, features that mate with an outer edge of the filter.

In this manner, a cost-effective means for filtering a flow of air is provided for residential and commercial settings. The filter mount is adaptable to a variety of standard box fan types of different styles and dimensions. The filter mount is configured to hook onto standard filters, such as those readily available from retail hardware stores and home centers. In one aspect, embodiments of the present inventive concepts include a removable filter mount for a fan including a first elastic band having a first end and a second end. The removable filter mount further includes a fan coupler extending from the first end of the first elastic band and constructed and arranged to be removably attached to a grill of a fan, and a filter coupler extending from the second end of the first elastic band and constructed and arranged to be removably attached to a fan filter. The first elastic band may be constructed and arranged to extend about a portion of a fan so that when installed, tension in the elastic band operates to secure the filter to the fan.

In some embodiments, the removable filter mount further includes a second elastic band having a first end and a second end, a fan coupler extending from the first end of the second elastic band and constructed and arranged to be removably attached to a grill of a fan, and a filter coupler extending from the second end of the second elastic band and constructed and arranged to be removably attached to a fan filter. The second elastic band may be constructed and arranged to extend about a portion of a fan so that when installed, tension in the first and second elastic bands operates to secure the filter to the fan.

In some embodiments, the fan coupler comprises a hook at the first end of the first elastic band to removably attach the first elastic band to the fan. In some embodiments, the hook of the first elastic band is constructed and arranged to grasp a grate of a fan grill.

In some embodiments, the filter coupler includes a first portion having a first end coupled to the first elastic band, a second portion having a first end extending from a second end of the first portion in a direction of extension substantially perpendicular to a direction of extension of the first portion, and a third portion extending from a second end of the second portion in a direction of extension substantially parallel to the direction of extension of the the first portion.

In some embodiments, the third portion extends in a direction of extension substantially perpendicular to the direction of extension of the second portion towards the first end of the first portion.

In some embodiments, the filter coupler further comprises a connection region constructed and arranged to mate with the first elastic band.

In some embodiments, the connection region extends from the first end of the first portion in a direction substantially perpendicular to the direction of extension of the first portion and in a direction opposite to the direction of extension of the second portion.

In another aspect, embodiments of the present inventive concepts include a method for mounting a filter to a fan including providing a first filter mount. The first filter mount may include a first elastic band having a first end and a second end, a first fan coupler extending from the first end of the first elastic band and constructed and arranged to be removably attached to a grill of a fan, and a first filter coupler extending from the second end of the first elastic band and constructed and arranged to be removably attached to a fan filter. The method further includes providing a second filter mount. The second filter mount may include a second elastic having a first end and a second end, a second fan coupler extending from the first end of the second elastic band and constructed and arranged to be removably attached to a grill of a fan, and a second filter coupler extending from the second end of the second elastic band and constructed and arranged to be removably attached to a fan filter. The method further includes removably attaching the first filter coupler of the first filter mount to a first side of a filter, removably attaching the second filter coupler of the second filter mount to a second side of the filter opposite to the first side of the filter, extending the first elastic band about a portion of a fan, extending the second elastic band about a portion of the fan, removably attaching the first and second fan couplers to the grill of the fan, and securing the filter to the fan by tensioning the first and second elastic bands about the fan.

In some embodiments, each of the first and second filter couplers includes a first portion having a first end coupled to the first elastic band, a second portion having a first end extending from a second end of the first portion in a direction of extension substantially perpendicular to a direction of extension of the first portion, and a third portion extending from a second end of the second portion in a direction of extension substantially parallel to the direction of extension of the the first portion.

In some embodiments, the removably attaching the first and second filter couplers the filter comprises hooking the first, second and third portions around an outer edge of the filter.

In some embodiments, the first and second fan couplers comprise hooks and removably attaching the elastic bands to the fan comprises securing the hooks to the grill of the fan.

### BRIEF DESCRIPTION OF THE DRAWINGS

The foregoing and other objects, features and advantages of the inventive concepts will be apparent from the more particular description of preferred embodiments, as illustrated in the accompanying drawings in which like reference characters refer to the same parts throughout the different views. The drawings are not necessarily to scale, emphasis instead being placed upon illustrating the principles of the inventive concepts.

FIG. 1 is a perspective view of a filter mount according to some embodiments of the present inventive concepts.

FIG. 2 is a perspective close-up view of a filter coupler of the filter mount of FIG. 1 according to some embodiments of the present inventive concepts.

FIG. 3 is a perspective close-up view of a fan coupler of the filter mount of FIG. 1 according to some embodiments of the present inventive concepts.

FIGS. 4A and 4B are front and rear perspective views of the filter mount of FIG. 1 illustrating the coupling of a filter to a box fan according to some embodiments of the present inventive concepts.

FIG. 5A is a close-up perspective view of the fan coupler of FIG. 3 coupled to a box fan according to some embodiments of the present inventive concepts. FIG. 5B is a close-up perspective view of the filter coupler of FIG. 2 coupled to a box fan according to some embodiments of the present inventive concepts.

### DETAILED DESCRIPTION OF EMBODIMENTS

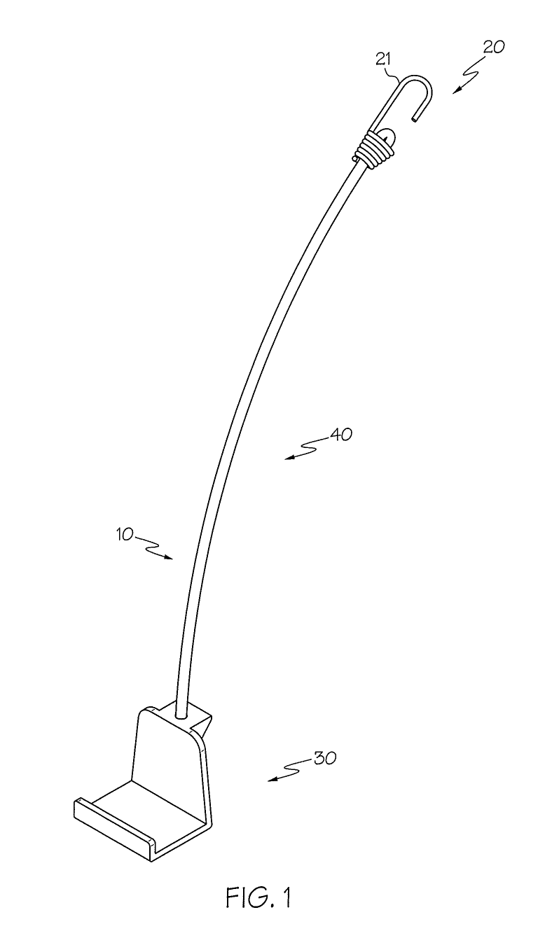

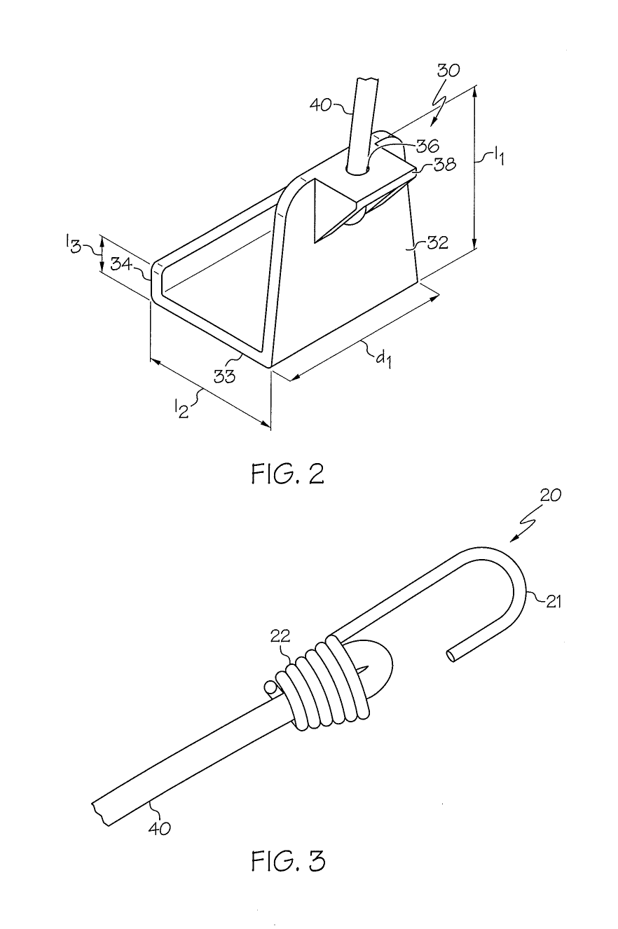

FIG. 1 is a perspective view of a filter mount 10 adapted to couple a standard air filter to a portable fan, such as a standard box fan, using a strap, for example, an elastic band 40. FIG. 2 is a close-up perspective view of a filter coupler 30 of the filter mount 10 of FIG. 1 according to some embodiments of the present inventive concepts. FIG. 3 is a close-up perspective view of a fan coupler 20 of the filter mount 10 of FIG. 1 according to some embodiments of the present inventive concepts.

In some embodiments, the filter mount 10 includes a fan coupler 20 and a filter coupler 30. The fan coupler 20 is positioned at a first end of an elastic strap 40 and the filter coupler 30 is positioned at a second, opposite, end of the elastic strap 40. The filter mount 10 is removably mountable between a portable fan and a standard air filter, such as the type of filter commonly used in residential heating systems. In some embodiments, when mounted, the filter mount 10 avoids permanent disfigurement to the fan body. The filter mount 10 is preferably sized to largely avoid interfering with air flow of the box fan.

In some embodiments, the filter mount 10 is in the form of a strap, for example, elastic band 40. The filter mount 10 is configured to secure the filter to the fan body, such that the filter is readily removable. In some embodiments, the straps 40 comprise elastic bands; however, the present inventive concepts are not limited thereto. For example, the straps 40 may, in some embodiments, comprise inelastic rope or ribbon. In an embodiment in which the straps comprise elastic bands 40, such bands may comprise, for example, bungy cords, elastic ribbons, or elastic straps. Tension in the outstretched elastic band 40, when mounted, operates to secure the filter to a grill of a fan. A first end of the strap includes a fan coupler 20 for coupling the elastic band 40 to the grill of the fan. A second, opposite, end of the elastic band 40 includes a filter coupler 30 for coupling the elastic band 40 directly to the filter. The fan coupler 20 includes features that attach to the protective grill of a fan, for example, features that mate with one or more grill apertures. In some embodiments, the fan coupler 20 includes a hook 21 sized to latch to the grill of a standard box fan. The filter coupler 30 includes features that attach to the filter, for example, features that mate with an outer edge of the filter.

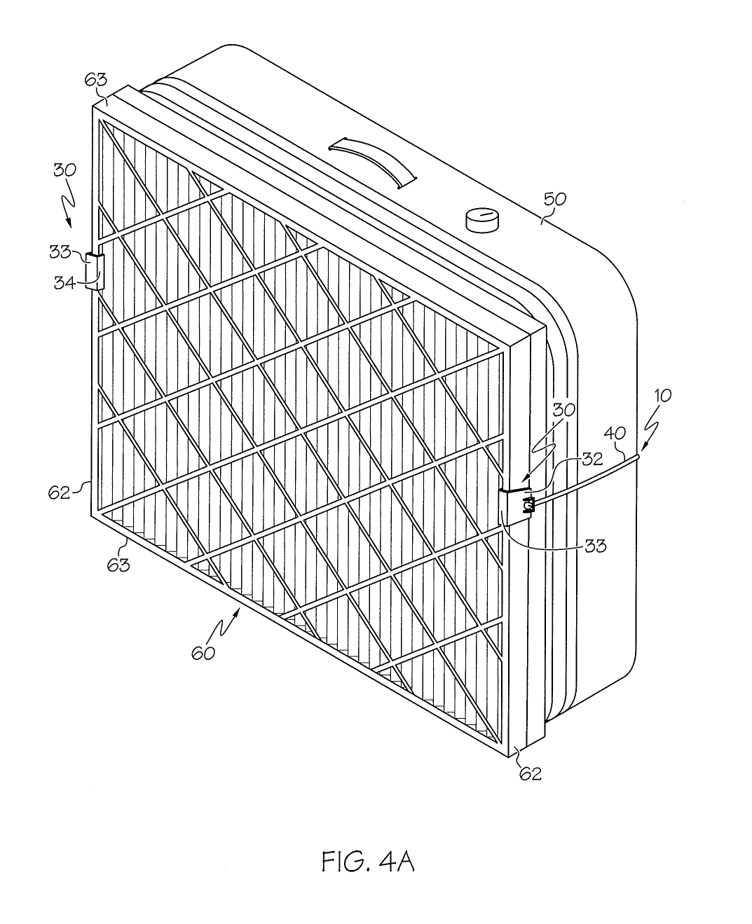

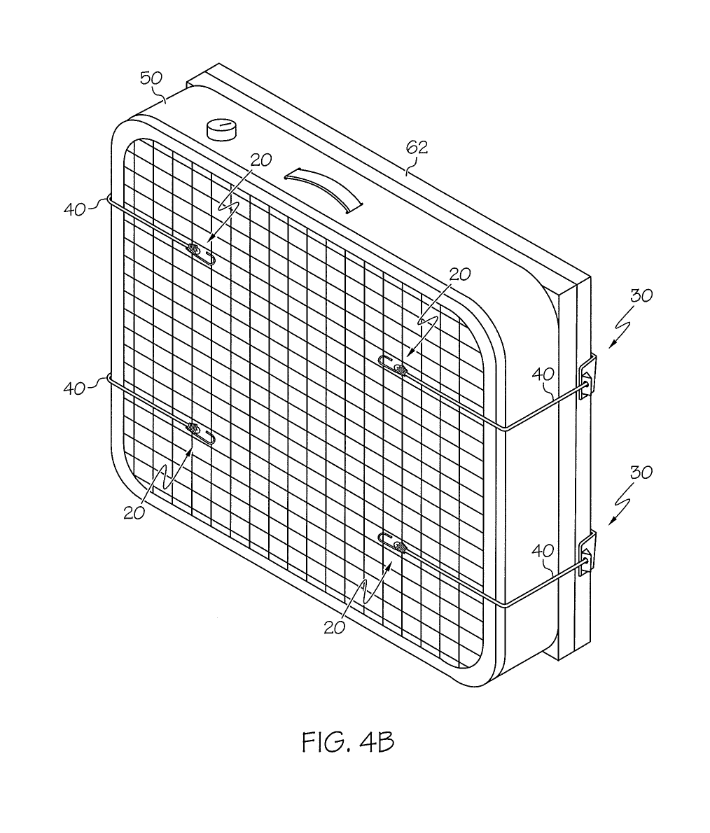

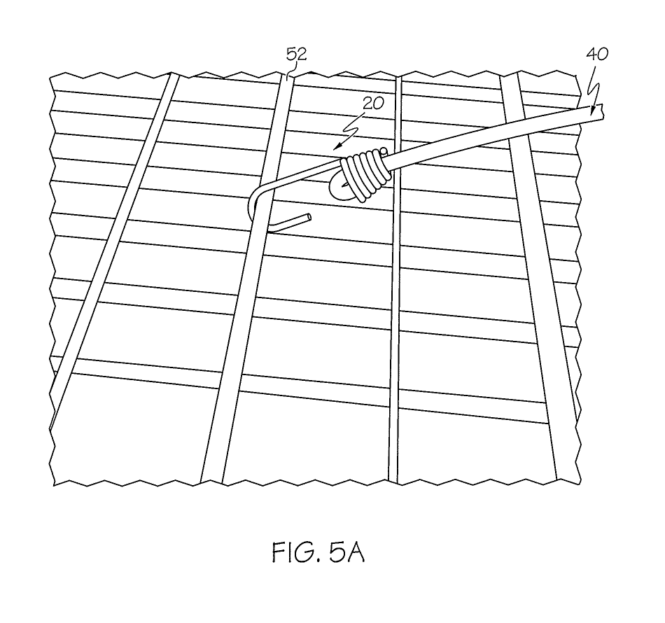

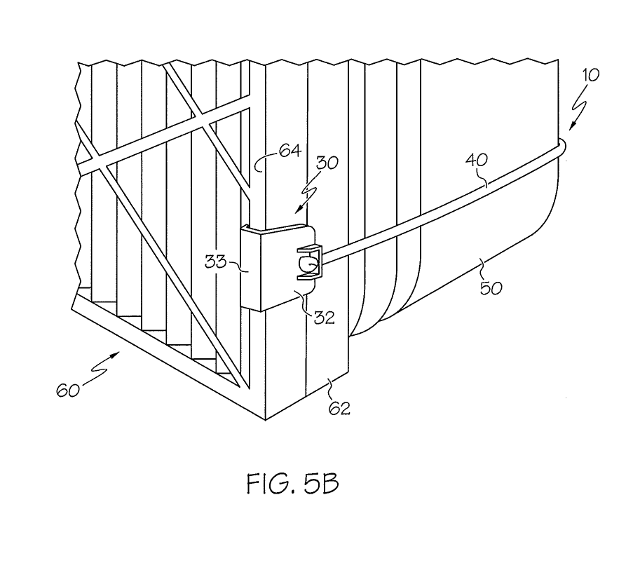

FIGS. 4A and 4B are front and rear perspective views of the filter mount 10 of FIG. 1 illustrating the coupling of a filter 60 to a body of a box fan 50 according to some embodiments of the present inventive concepts. FIG. 5A is a close-up perspective view of the fan coupler 20 of FIG. 3 coupled to the box fan 50 according to some embodiments of the present inventive concepts. FIG. 5B is a close-up perspective view of the filter coupler 30 of FIG. 2 coupled to the filter 60 according to some embodiments of the present inventive concepts

Referring to FIGS. 1 and 3, the fan coupler 20 includes, for example, a hook 21, or other clasping mechanism and is coupled to a first end of the elastic band 40. The hook 21 of the fan coupler 20 may be tied, coupled to, or integral with, the elastic band 40. In some embodiments, the hook 21 may be coupled to the elastic band 40 using a standard retaining mechanism 22. For example, the hook 21 and the retaining mechanism 22 may include a stiff wire. The end of the elastic band 40 may be doubled over and one end of the retaining mechanism 22 including the stiff wire may be tightly coiled around the doubled over end of the elastic band 40. The other end of the stiff wire may be bent into a j-shaped hook, for example, the hook 21. The hook 21 is preferably coated with a soft plastic or rubber material to avoid scratching the fan grill. Referring to FIGS. 4B and 5A, the fan coupler 20 is constructed and arranged to grasp or hook onto a grate of a fan grill 52 of a portable fan 50 at an input or output face of the fan 50 The elastic bands 40 and fan couplers 20 present a relatively small surface area relative to the box fan 50 so as to substantially avoid interfering with air flow. That is, the fan coupler 20 and elastic band 40 block a minimal amount of air passing through the fan grills 52.

Referring to FIGS. 4A and 5B, the filter coupler 30 is constructed and arranged to mate with a standard air filter, for example, filter 60. The standard air filter 60 may include a cardboard frame surrounding the filter. The filter 60 may include a standard air filter, a universal pre-filter and/or a High Efficiency Particulate Air (HEPA) type filter. In some embodiments, an optional foam pad or gasket may be applied between the filter 60 and the fan 50. The foam pad may include an opening that allows free passage of air, the opening being about as large as the cross-section of the volume of air that the fan is designed to push, so as not to restrict air flow. The foam pad prevents air from entering the fan at a gap that may be present between the filter and the surface of the fan 50. In this manner, the foam pad causes more of the air that is pushed by the fan to pass through the filter 60, thereby improving the air cleaning efficiency of the system. Further, if the foam pad is cut to closely match the diameter of the fan blades, back draft in the corners of the box fan can be prevented. By preventing the back draft in the box fan, an air flow can be created that flows in a single direction, thus making the fan more efficient in configurations in which negative air pressure would otherwise be created.

In some embodiments, the filter 60 may include a frame including side surfaces 62 extending in a substantially vertical direction of extension connected by side surfaces 63 extending in a substantially horizontal direction of extension.

Referring to FIGS. 1, 2 and 4A, the filter coupler 30 includes a clasping mechanism. The clasping mechanism is constructed and arranged to grip or hook onto a side portion of a standard filter. The clasping mechanism may include a first portion 32 having a first length l₁, a second portion 33 having a second length l₂ and a third portion 34 having a third length l₃. In some embodiments, the first length l₁ is approximately one inch. In some embodiments, the length l₂ is approximately the same length as a front face 64, as seen in FIG. 5B, of cardboard frame of the filter 60. That is, the second portion 33 may be aligned with the front face 64 such that no space is formed between the third portion 34 and the edge of filter 60. In some embodiments, the length l₃ is of a sufficient length to hold the filter coupler in place and stop the filter coupler 30 from sliding.

The first portion 32 of the filter coupler 30 is coupled to a second end of the elastic band 40. In FIGS. 1 and 2, a connection region 38 extends from a first end of the first portion 32 in a direction of extension substantially perpendicular to the direction of extension of the first portion 32. The connection region 38 includes a hole 36 through which the elastic band 40 extends. The elastic band 40 includes a stop, for example, a knot, which prevents the elastic band from being released from the connection region 38. For example, in the present embodiment, the elastic band 40 includes a knot which prevents the end of the elastic band from being released from hole 36 of the connection region 38. That is, the elastic band 40 extends through the hole 36 and the knot at the end of the elastic band 40 is larger than the hole 36, thus preventing the elastic band from being released from the hole 36. In some embodiments, the first portion 32 of the filter coupler 30 may be tied, coupled to, or integral with, the elastic band 40. Referring to FIG. 4A, the filter coupler 30 is constructed and arranged to hook onto a side portion of the filter 60 which is positioned along an input or output face of the fan 50, so that a substantial amount of air flow induced by the fan passes through the filter. That is, the filter coupler 30 and elastic band 40 block a minimal amount of air passing through the fan grill 52.

The first portion 32 of the filter coupler 30 is constructed and arranged to communicate with one of the vertical side surfaces 62 of the filter 60. A first end of the second portion 33 of the filter coupler extends from a second end of the first portion 32 in a direction of extension substantially perpendicular to the direction of extension of the first portion 32. A face of the first portion 32 extends a distance di. The second portion 33 extends in a direction opposite to that of the connection region 38. The second portion 33 is constructed and arranged to extend along a front face 64 of the filter 60 when coupled to the filter 60. A face of the second portion 33 extends the distance di. The third portion 34 of the filter coupler 30 extends from a second end of the second portion 33 in a direction substantially perpendicular to the direction of extension of the second portion 33 towards the first end of the first portion 32. That is, the third portion 34 extends parallel to the first portion 32. The third portion 34 mates with an inner portion of the filter 60. The third portion 34 extends into an internal portion of the filter. A face of the third portion 34 extends the distance di. The length l₃ of the third portion 34 is shorter than the length l₁ of the first portion 32. The length l₃ of the third portion is less than half the length l₁ of the first portion 32. The length l₃ of the third portion 34 is shorter than the length l₂ of the second portion 33. The filter coupler 30 is configured or otherwised constructed and arranged to be hooked directly to the filter 60. The filter coupler 30 fits square with filter 60 as the elastic band 40 pulls the filter coupler 30 such that there is no pivot between the filter coupler 30 and the filter 60.

As seen in FIGS. 4A and 4B, first and second filter couplers 30 of first and second filter mounts 10 may be hooked onto the filter 60 along the sides 62 of the filter 60, respectively. The filter 60 may be positioned along a grill of the fan at a first face of the fan 50. The filter 60 may include multiple filters. The elastic bands 40 of the first and second filter mounts 10 are pulled about the sides of the fan chassis to a second face of the fan 50 which is opposite the first face of the fan 50. The hooks of the fan couplers 20 are clasped to an existing feature of the box fan 50, for example, a grate of a grill 52 on the second face of the fan 50. Tension in the stretched elastic bands 40 retains the filter 60 against the fan 50. Although the above described embodiment illustrates first and second filter mounts 10, the present inventive concepts are not limited thereto.

According to the present inventive concepts, the first end of the elastic band 40 is removably coupled to the fan and the second of the elastic band 40 is removably coupled to the filter. The second end of on the elastic band 40 is coupled directly to the filter without the need of a filter frame.

In alternative embodiments, the filter coupler 30 may be constructed and arranged to mate with a filter frame. That is, the filter may be inserted in a filter frame, for example, a filter frame as disclosed in U.S. Pat. No. 7,670,401, and the second end of the elastic band 40 may be removably coupled to the filter frame.

According to the filter mount of the present inventive concepts, a cost-effective means for filtering a flow of air is provided for residential and commercial settings. The filter mount is adaptable to a variety of standard box fan types of different styles and dimensions. The filter mount is configured to hook onto standard filters, such as those readily available from retail hardware stores and home centers.

While this invention has been particularly shown and described with references to preferred embodiments thereof, it will be understood by those skilled in the art that various changes in form and details may be made herein without departing from the spirit and scope of the invention as defined by the appended claims.

1. A removable filter mount for a fan, comprising:
a first elastic band having a first end and a second end;
a fan coupler extending from the first end of the first elastic band and constructed and arranged to be removably attached to a grill of a fan; and
a filter coupler extending from the second end of the first elastic band and constructed and arranged to be removably attached to a fan filter,
the first elastic band being constructed and arranged to extend about a portion of a fan so that when installed, tension in the elastic band operates to secure the filter to the fan.

2. The removable filter mount of claim 1, further comprising:
a second elastic band having a first end and a second end;
a fan coupler extending from the first end of the second elastic band and constructed and arranged to be removably attached to a grill of a fan; and
a filter coupler extending from the second end of the second elastic band and constructed and arranged to be removably attached to a fan filter,
the second elastic band being constructed and arranged to extend about a portion of a fan so that when installed, tension in the first and second elastic bands operates to secure the filter to the fan.

3. The removable filter mount of claim 1, wherein the fan coupler comprises a hook at the first end of the first elastic band to removably attach the first elastic band to the fan.

4. The removable filter mount of claim 3, wherein the hook of the first elastic band is constructed and arranged to grasp a grate of a fan grill.

5. The removable filter mount of claim 1, wherein the filter coupler comprises:
a first portion having a first end coupled to the first elastic band;
a second portion having a first end extending from a second end of the first portion in a direction of extension substantially perpendicular to a direction of extension of the first portion; and
a third portion extending from a second end of the second portion in a direction of extension substantially parallel to the direction of extension of the the first portion.

6. The removable filter mount of claim 5, wherein the third portion extends in a direction of extension substantially perpendicular to the direction of extension of the second portion towards the first end of the first portion.

7. The removable filter mount of claim 5, wherein the filter coupler further comprises a connection region constructed and arranged to mate with the first elastic band.

8. The removable filter mount of claim 7, wherein the connection region extends from the first end of the first portion in a direction substantially perpendicular to the direction of extension of the first portion and in a direction opposite to the direction of extension of the second portion.

9. A method for mounting a filter to a fan, comprising:
providing a first filter mount, the first filter mount including:
a first elastic band having a first end and a second end;
a first fan coupler extending from the first end of the first elastic band and constructed and arranged to be removably attached to a grill of a fan; and
a first filter coupler extending from the second end of the first elastic band and constructed and arranged to be removably attached to a fan filter;
providing a second filter mount, the second filter mount including:
a second elastic having a first end and a second end;
a second fan coupler extending from the first end of the second elastic band and constructed and arranged to be removably attached to a grill of a fan; and
a second filter coupler extending from the second end of the second elastic band and constructed and arranged to be removably attached to a fan filter,
removably attaching the first filter coupler of the first filter mount to a first side of a filter;
removably attaching the second filter coupler of the second filter mount to a second side of the filter opposite to the first side of the filter;
extending the first elastic band about a portion of a fan;
extending the second elastic band about a portion of the fan;
removably attaching the first and second fan couplers to the grill of the fan; and
securing the filter to the fan by tensioning the first and second elastic bands about the fan.

10. The method of claim 9 wherein each of the first and second filter couplers comprises:
a first portion having a first end coupled to the first elastic band;
a second portion having a first end extending from a second end of the first portion in a direction of extension substantially perpendicular to a direction of extension of the first portion; and
a third portion extending from a second end of the second portion in a direction of extension substantially parallel to the direction of extension of the the first portion.

11. The method of claim 10, wherein the removably attaching the first and second filter couplers the filter comprises hooking the first, second and third portions around an outer edge of the filter.

12. The method of claim 9 wherein the first and second fan couplers comprise hooks and removably attaching the elastic bands to the fan comprises securing the hooks to the grill of the fan.
